(19) United States
(12) Patent Application Publication
(10) Pub. No.: US 2004/0101817 A1
(43) Pub. Date: May 27, 2004

(54) Computer specific software application teaching system

(76) Inventor: Markell Boulis, Presto, PA (US)

Correspondence Address: CAROTHERS AND CAROTHERS, Suite 500, 445 Fort Pitt Blvd., Pittsburgh, PA, 15219, US

(21) Appl. No.: 10/303,636

(22) Filed: Nov. 25, 2002

(51) Int. Cl. G09B 5/00

(52) U.S. Cl. 434/307 R; 434/308; 434/362

(57) ABSTRACT

A teaching system for teaching specific software application programs on a computer which includes a controller learning program programmed on the computer. Selected computer keyboard and mouse keys are illuminated with the colors red, green or yellow for indicated necessary key functions for carrying out selected functions of the specific program or for correcting the user on testing applications. The controller learning program may be voice activated and further provides picture-in-picture display instructions on the monitor for instructing the student how to perform the function to be learned.

### FIELD OF THE INVENTION

The present invention relates to a computer utilizing interactive illuminated keys on peripherals for teaching specific software application programs on the computer.

### BACKGROUND OF THE INVENTION

A considerable number of teaching and learning systems have been developed over the years for assisting students or users in learning how to use specific software application programs on a computer. However, these prior art methods are considered to be deficient because they do not truly provide fully interactive computer systems which can provide a most simplified, easy to use and fastest learning system possible. It is with this object in mind that the present invention has been developed.

### SUMMARY OF THE INVENTION

The teaching system of the present invention provides a method for teaching a specific software application program on a computer wherein the program to be learned is activated on the computer and a controller learning program is also activated on the computer for the specific program to be learned. The computer is programmed for illuminating selected computer keyboard and mouse keys for the computer with a desired multiple number of colors for indicating necessary key functions to carry out selected functions of the specific program. The illuminated keys are used in two different modes of operation, one for teaching and one for testing.

In the testing mode the keys are illuminated in response to keys on the keyboard and/or the mouse which are depressed by the computer operator for indicating correctness and incorrectness of the keys depressed by the operator in response to the functions of the specific program to be learned and carried out. For example, the multiple colors selected to illuminate each key might be selected as red, green and yellow. Illumination of the key as red indicates that the operator has made an error and depressed the incorrect key. Illumination of the key as green means that the operator has depressed the correct key. Illumination of the key as yellow may indicate caution or may indicate that this procedure or key may be pressed but there is a better or alternative procedure for accomplishing the task.

In the teaching mode, as opposed to the examination or testing mode, the keys may be illuminated prior to depressing of the key by the computer operator to indicate the proper keys to be depressed, the alternative keys which may be depressed and those keys on the keyboard or mouse which should not be depressed.

The learning system of the present invention becomes fully functional when combined with the controller learning program which may be initiated by voice command. In addition, the controller learning program includes the provision of picture-in-picture display instructions for performing the functions to be learned or carried out after initiation of the voice command by the operator.

The specific computer software application learning program of the present invention accordingly permits the student to learn many different computer programs and completely eliminates the need for a classroom surrounding and permits the student to learn at his or her own pace. The learning system of the present invention therefore helps the computer illiterate to become fully computer trained and competent with no outside interference.

### BRIEF DESCRIPTION OF THE DRAWINGS

Other objects and advantages appear hereinafter in the following description and claims. The accompanying drawings show, for the purpose of exemplification, without limiting the scope of the invention or appended claims, certain practical embodiments of the present invention wherein:

FIG. 1 is a schematic drawing illustrating an example computer system or PC with peripherals which can be utilized for the teaching apparatus and method of the present invention; and

FIG. 2 is a flowchart illustrating an example of the computer teaching system of the present invention.

### DETAILED DESCRIPTION OF THE PREFERRED EMBODIMENTS

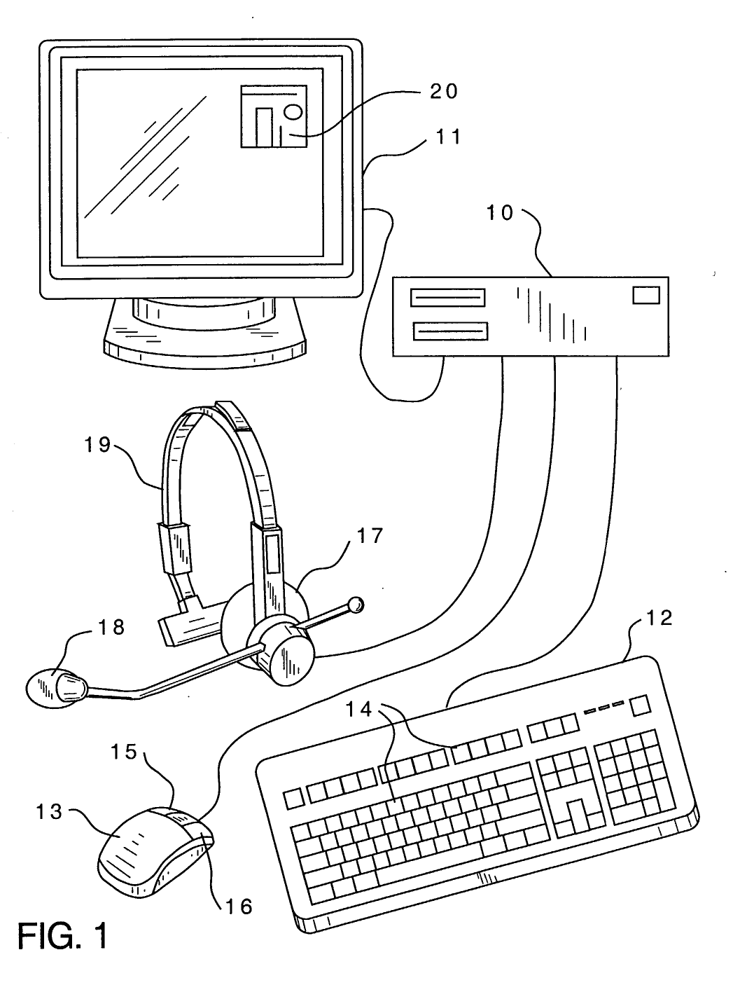

Referring to FIG. 1, the computer which may be used in conjunction with the learning system of the present invention may be of any conventional type PC or Macintosh, and may be for example, a desktop, laptop, notebook or other type conventional computer. The computer illustrated in FIG. 1 is of a conventional desktop type PC. The computer system illustrated includes a central processing unit 10 which conventionally includes a memory, including read only memory (ROM) and random access memory (RAM), and a system bus connected to the central processing unit. A display device in the form of monitor 11 is also connected to the central processing unit. In addition, other conventional peripherals are provided in the form of keyboard 12 and mouse 13 which are connected to the central processing unit.

The keyboard 12 is conventional in all respects except that the keys 14 are programmably illuminable in one of three colors; namely, red, yellow and green.

In addition, the buttons or keys 15 and 16 on mouse 13 are also programmably illuminable in three colors, the key 15 being the conventional left click key and the key 16 being the conventional right click key.

The manner in which the keys 14 of keyboard 12 and the keys 15 and 16 of mouse 13 are illuminated is not important to the specifics of the present invention. There are many prior art teachings as to how this can be readily accomplished. For example, see U.S. Pat. Nos. 4,551,717; 5,801,345; 5,818,361; 6,199,996; 6,217,183 and 6,281,812. These references do not suggest the illumination of mouse keys as directed by the present invention, and nevertheless, the same techniques may be employed for illuminating the mouse keys 15 an 16.

The computer system of the present invention further includes a headset 19 with a speaker 17 and a microphone 18, and the central processing unit 10 is programmed with voice activated software so that voice commands may be initiated by the student or computer operator. In addition, the central processing unit 10 is also programmed with computer learning software for teaching proper use procedure for specific computer software programmed into the central processing unit. This learning software further includes picture-in-picture display capabilities for the display device 11 as illustrated at 20. This learning software further includes auditory command capabilities for the speaker 18 input on headset 19. The central processing unit 10 is programmed to selectively illuminate the keyboard keys 14 and mouse keys 15 and 16 with one of the three colors in response to a specific software application program for training the operator or student to use the specific program.

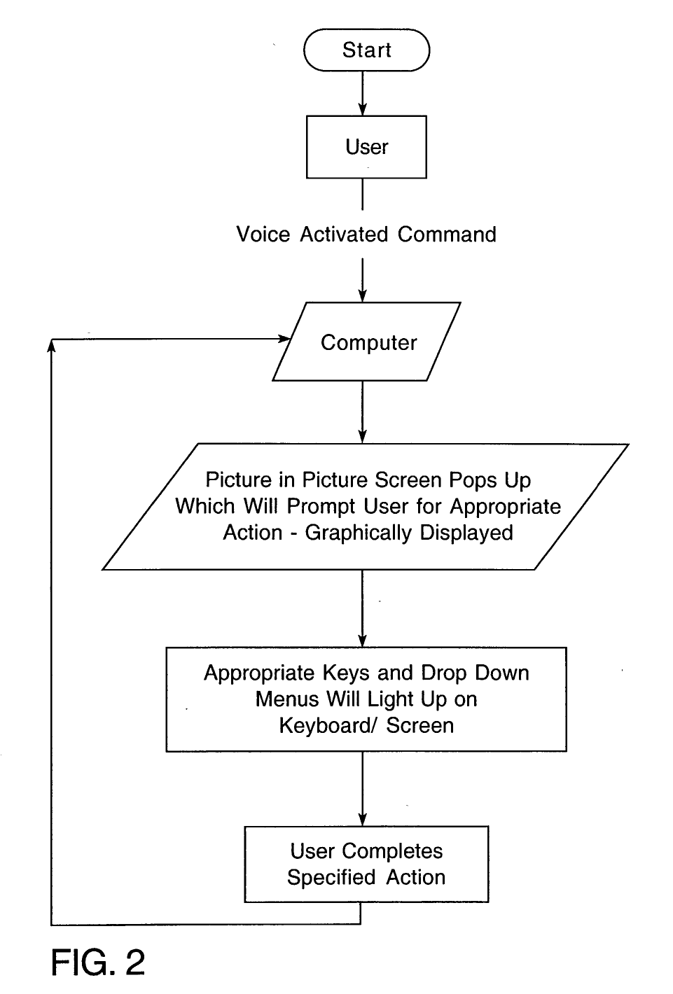

An example as to how the system of the present invention functions is provided by reference to the flowchart of FIG. 2.

At the Start, the programmed computer 10, which has been preprogrammed with the specific software application program to be learned and also with a controller learning program for the specific program to be learned, the user, through voice activated commands with microphone 18 activates the computer learning software or controller learning program software which in turn activates a picture-in-picture screen pop-up 20 on display 11 which will prompt the user for appropriate action, which is graphically displayed, in order to carry out the function to be learned. For example, assuming that a user wants to learn how to save a document in a word processing program to a floppy disk. The user then uses the microphone 18 and the voice activated software programmed into central processing unit 10 and speaks into the microphone saying “save disk”. The window pop-up 20 appears and provides the user with the correct choices pertaining to the procedures which must be carried out for saving the document to a floppy disk. The user chooses the correct subject with his mouse, as prompted by the illuminated mouse keys, using the pop-up picture-in-picture 20 in the picture monitor for tutorial guidance.

The learning program of the central processing unit 10 simultaneously lights up or illuminates the proper keys 14 and/or mouse keys 15 or 16 with LED or other appropriate lighting to indicate the proper sequence that must be carried out for depressing these keys to carry out the desired function.

The user then proceeds to press the indicated proper keys. If the user presses the proper keys in the proper sequence, the keys will illuminate green and permit the user to move forward. If the wrong key is pressed and error audio signal will be generated through speaker 17 and a red light will also illuminate the incorrect key depressed. A yellow illumination of a key for the keyboard or mouse indicates either caution or that alternate techniques or functions exist for carrying out the desired function. The illuminated keys and the pop-up screen in the display will indicate to the user whether or not the task has been carried out correctly and indicate what procedures must be carried out if the procedure was incorrectly carried out by the student.

I claim:

1. A computer and computer learning system combination, comprising;
a central unit;
a ROM, a RAM and a system bus connected to said central processing unit;
a display device connected to said central processing unit;
a keyboard connected to said central processing unit; and
a mouse connected to said central processing unit;
said keyboard and said mouse having keys which are programmably illuminable in selected multiple colors.

2. The combination of claim 1, including a speaker and a microphone connected to said central processing unit;
said processing unit programmed with voice activated software.

3. The combination of claim 2, wherein said central processing unit is programmed with computer learning software for teaching proper use procedure for specific computer software programmed into said central processing unit, said learning software including picture-in-picture display capabilities for said display device.

4. The combination of claim 3, wherein said learning software includes auditory command capabilities for said speaker.

5. The combination of claim 1, wherein the multiple colors are red, green and yellow.

6. The combination of claim 1, said central processing unit programmed to selectively illuminate said keyboard and mouse keys with one of the multiple colors in response to a specific software application program for training an operator to use the program.

7. A method for teaching a specific software application program on a computer, said method comprising;
activating the program on the computer;
activating a controller learning program for said specific program on the computer;
and illuminating selected computer keyboard and mouse keys for the computer with selected of multiple colors for indicating necessary key functions for carrying out selected functions of the specific program.

8. The method of claim 7, wherein said keys are illuminated in response to keys depressed by a computer operator for further indicating correctness and incorrectness of the keys depressed by the operator in response to the functions of the specific program to be carried out.

9. The method of claim 8, wherein the multiple colors are selected as red, green and yellow.

10. The method of claim 7, wherein the step of activating the controller learning program is initiated by voice command.

11. The method of claim 10, wherein activating the controller learning program includes providing picture-in-picture display instructions for performing the function to be learned.
